(19) United States
(12) Patent Application Publication
(10) Pub. No.: US 2017/0358877 A1
(43) Pub. Date: Dec. 14, 2017

(54) PIN ALIGNMENT FIXTURE

(71) Applicant: U.S.A. as represented by the Administrator of the National Aeronautics and Space Administration, Washington, DC (US)

(72) Inventors: DAVID J. PETRICK, SEVERNA PARK, MD (US); MICHAEL R. LIN, ELLICOTT CITY, MD (US)

(21) Appl. No.: 15/179,020

(22) Filed: Jun. 10, 2016

(51) Int. Cl. H01R 12/70

(52) U.S. Cl. CPC H01R 12/7052; H01R 12/7082

(57) ABSTRACT

A stacking pin alignment fixture for a stacking connector includes a substrate and a plurality of openings defined in the substrate, the plurality of openings being arranged in a predefined pattern. The predefined pattern corresponds to a pattern of a field of straight pins arranged on the stacking connector.

### INVENTION BY GOVERNMENT EMPLOYEE(S) ONLY

The invention described herein was made by an employee of the United States Government, and may be manufactured and used by or for the Government for governmental purposes without the payment of any royalties thereon or therefor.

### FIELD

The aspects of the present disclosure relate generally to connectors and in particular to pin alignment fixture for connectors having long pins.

### BACKGROUND

A stacking pin connector can have inherently long pins. Typically, the pins in a stacking pin connector can be as long as three inches. The longer the pin, the less “straight” they tend to be, and therefore are more prone to bending. The pins can bend easily during shipping, handling and installation. Depending upon how the connectors are packaged for shipping, it is not uncommon for the pins to be bent or misaligned when they arrive from the manufacturer. When there are more pins in a connector, more mating force can be required. If there is more mating force required, and the pins are ling, the easier it can be to bend the pins.

When the pins bend, they will not align with the mating connector. When the connector portions are mated, a bent or misaligned pin will not be properly received or mate, electrically. This can result in an open circuit, or even a short circuit if a bent pin makes contact with another pin. This can cause damage or render the equipment inoperable, which is unacceptable in space applications and other high reliability applications.

Accordingly, it would be desirable to provide a pin alignment fixture that addresses at least some of the problems identified above.

### SUMMARY

The aspects of the disclosed embodiments are directed to a pin alignment fixture. The advantages provided by aspects of the disclosed embodiments are achieved by the subject matter of the independent claims. Further advantageous modifications can be found in the dependent claims.

According to a first aspect, the disclosed embodiments are directed to a stacking pin alignment fixture for a stacking connector. In one embodiment, the stacking pin alignment fixture includes a substrate, a plurality of openings defined in the substrate, the plurality of openings being arranged in a predefined pattern, wherein the predefined pattern corresponds to a pattern of a field of straight pins arranged on the stacking connector

In a first possible implementation form of the stacking pin alignment fixture according to the first aspect, the substrate comprises an electrically non-conductive board.

In a second possible implementation form of the stacking pin alignment fixture according to the first aspect the substrate is a substantially stiff board having a thickness of approximately 1 millimeter.

In a third possible implementation form of the stacking pin alignment fixture according to the first and second aspects the plurality of openings in the substrate are configured to be aligned with the pattern of the field of straight pins of the stacking connector when the substrate is placed onto the field of straight pins.

In a fourth possible implementation form according of the stacking pin alignment fixture according to any of the preceding possible implementation forms the substrate is configured to move up and down a length of each straight pin in the field of straight pins when a substantially equal force is applied to both sides of the substrate.

In a fifth possible implementation form of the stacking pin alignment fixture according to any of the preceding possible implementation forms the substrate is configured to maintain each pin in the field of straight pins in a substantially straight position when the substrate is placed onto the field of straight pins.

In a sixth possible implementation form of the stacking pin alignment fixture according to any of the preceding possible implementation forms a length of each pin in the field of straight pins is approximately three-inches.

In a seventh possible implementation form of the stacking pin alignment fixture according to any of the preceding possible implementation forms the pre-defined pattern corresponds to an Airborn HMM series connector with 122 pins.

In an eighth possible implementation form of the stacking pin alignment fixture according to any of the preceding possible implementation forms a length of the substrate is approximately three-inches, and a thickness is approximately 1 millimeter.

In a ninth possible implementation form of the stacking pin alignment fixture according to any of the preceding possible implementation forms the substrate is configured to slide up and down the pins in the field of straight pins.

According to a second aspect, the disclosed embodiments are directed to a stacking pin connector configured for space flight. In one embodiment, the stacking pin connector includes a plurality of spaced-apart straight pins arranged in a pre-defined pattern on a first portion of the connector; a mating portion of the connector comprising a plurality of openings, wherein each opening is configured to receive a straight pin of the plurality of straight pins; and a substrate having a plurality of spaced-apart openings defined therein, the plurality of spaced-apart openings being arranged in a pattern corresponding to the pre-defined pattern of spaced-apart straight pins, wherein the substrate is configured to be mounted onto the plurality of spaced-apart straight pins to maintain each pin in a substantially straight position.

According to a first possible implementation form of the connector according to the second aspect the substrate is configured to be positioned between the first portion of the connector and the mating portion of the connector when the first portion is connected to the mating portion.

In a first possible implementation form of the connector according to the second aspect, the substrate is a substantially stiff board member, having thickness of approximately 1 millimeter.

In a second possible implementation form of the connector according to the first possible implementation forms the substrate is configured to slide up and down the plurality of pins when substantially equal forces are applied to each side of the substrate.

In a third possible implementation form of the connector according to the first and second possible implementation forms of the second aspect the substrate substantially prevents lateral movement of the straight pins in the plurality of pins.

In a fourth possible implementation form of the connector according to any of the preceding implementation forms the connector is a 122-pin stacking connector.

In a fifth possible implementation form of the connector according to any of the preceding implementation forms the connector is a stacking connector for an avionics assembly board of a spacecraft.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following, the invention will be explained in more detail with reference to the example embodiments shown in the drawings, in which:

FIG. 1 is a plan view of an exemplary stacking pin alignment fixture incorporating aspects of the disclosed embodiments.

FIG. 2 illustrates an exemplary straight pin connector.

FIG. 3 illustrates an avionics board with a straight pin connector and a pin alignment fixture incorporating aspects of the disclosed embodiments.

FIG. 4 illustrates an exemplary straight pin connector with a pin alignment fixture incorporating aspects of the disclosed embodiments glued in place.

### DETAILED DESCRIPTION OF THE DISCLOSED EMBODIMENTS

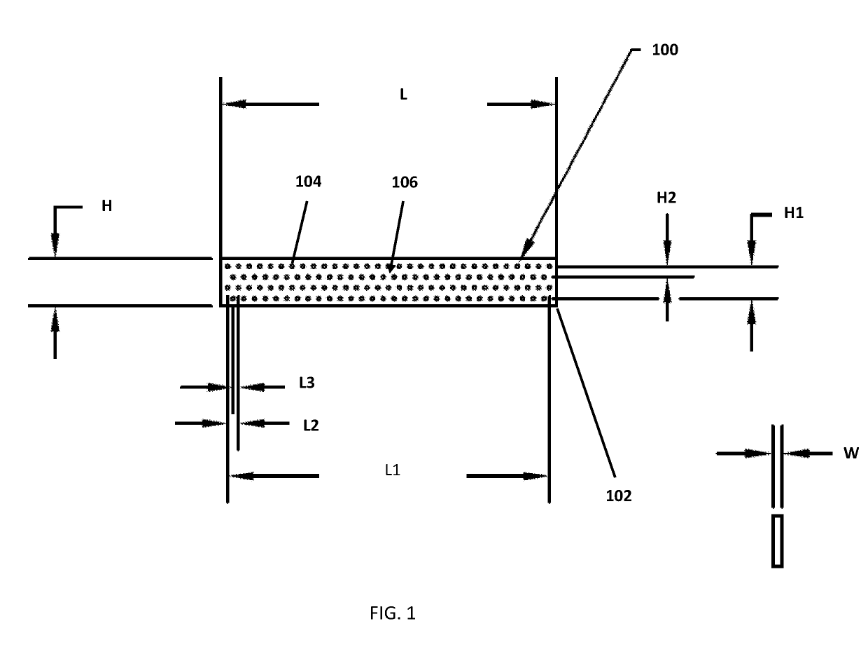

Referring to FIG. 1, the aspects of the disclosed embodiments are directed to a pin alignment fixture for a stacking connector. Although the aspects of the disclosed embodiments will be described herein with respect to a stacking connector, the aspects of the disclosed embodiments are not so limited. In alternate embodiments, the pin alignment fixture of the disclosed embodiments can be used with any type and size of connector having pins that are susceptible to bending, such as a connector with long pins. A “pin” as that term is used herein, generally refers to a metal conductor. The metal conductor can have three dimension-length, width1 and width2. A cylindrical pin has a length and a radius. The aspects of the disclosed embodiments can apply to any type of pin, having any suitable shape and length.

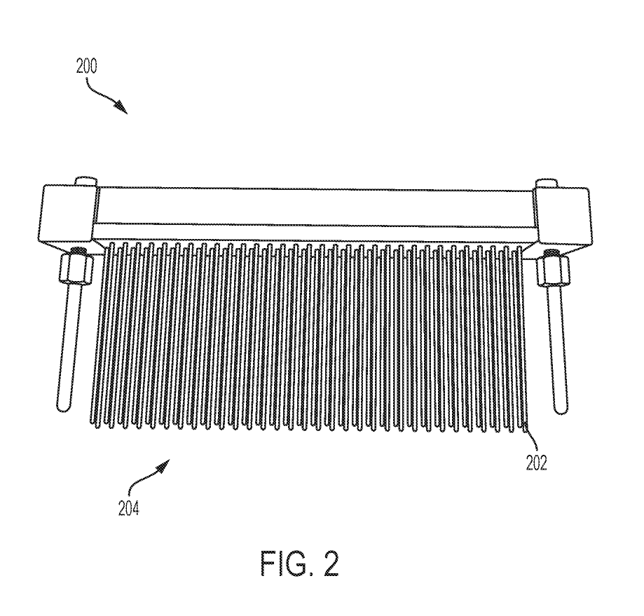

A stacking connector is a connector type that has inherently long pins. An exemplary dimension of long pins is in the range of approximately one inch to three inches. An example of a stacking connector is shown in FIG. 2. Due to the length of the pins, they bend easily. This can cause connectivity problems among other things when mating the different connector ends or pairs together. A bent pin can result in no connection, or even short circuits, which can result in permanent damage. For space applications and other high reliability applications, this can be unacceptable. Thus, there is a significant importance in ensuring that the pins of a stacking connector remain straight in order to ensure proper alignment and connectivity when the connector pairs are mated together.

FIG. 1 illustrates one example of a pin alignment fixture 100 incorporating aspects of the disclosed embodiments. In the example of FIG. 1, the pin alignment fixture 100 includes a substrate or board 102. For purposes of the disclosure herein, the substrate 102 will be referred to as a board. The board 102 has a length L, a height H and a width W. Exemplary dimensions for the length L are in the range of two to three inches. An exemplary height H of the substrate 102 might be in the range of approximately one quarter inch to one inch. An exemplary width or thickness of the substrate 102 can be approximately 40 mils (thousandths of an inch), or in the range of approximately one to two millimeters. While certain exemplary dimensions are provided for then substrate 102, the aspects of the disclosed embodiments are not so limited. In alternate embodiments, the length, height and thickness of the substrate 102 can be any suitable dimensions, depending upon the application, the particular connector, the number of pins, the pattern layout of the pins, as well as the length of the pins. For example, in one embodiment, a thickness of the substrate 102 can be determined as the length of the pins minus the mating connector depth (i.e. max_fixture_thickness=min_pin_length−max_mating_depth). In some applications, the thickness W of the substrate 102 can be almost as long as the connector pins. As will be described below, the substrate 102 for the pin alignment fixture 100 can be configured to correspond to the mating connector assembly in which the pin alignment fixture will be implemented.

Referring again to FIG. 1, the material of the substrate 102 is any suitable material that provides stiffness, is generally non-conductive and resists thermal expansion. The pin alignment fixture 100 of the disclosed embodiments is configured for space flight, where it will be subject to extreme stresses, including vibration and temperature, as is generally understood. For example, the substrate 102 and pin alignment fixture 100 will be configured for operation in rugged environments, such as rocket launches. In one embodiment, the material of the substrate can include a circuit board material. In alternate embodiments, any suitable material can be used that can include holes for aligning with a field of pins in a connector, such as a stacking connector.

In one embodiment, the substrate 102 includes a plurality of holes or openings 104. The plurality of holes 104 are arranged in a pre-defined pattern 106. The pattern 106 will generally correspond to the pin pattern of a corresponding connector, as will be further illustrated below. In one embodiment, as is described below, the pin pattern of the corresponding connector is referred to as a field of pins.

The holes 104 are suitably sized to receive the pins of the corresponding connector. In one embodiment, a size of the holes 104 will include a minimal amount of tolerance that allows for the pin alignment fixture 100 to be inserted onto the pins of the corresponding connector. In one embodiment, the size of the openings or holes 4 can generally be driven by the min/max pin thickness tolerances provided by the manufacturer of the connectors and pins.

In one embodiment, the pin alignment fixture 100 is configured for a pin connector having a 122 pin pattern that is centered on the board 100. Although a 122 pin pattern is used in this example, it will be understood that the pin alignment fixture 100 can be used with any suitable connector having any number of pins of any suitable size. In this example, the length L of the board 102 is approximately 2.355 inches+/−0.010. The distance L1 is approximately 2.250 inches. The distance L2 is approximately 0.75 inches, while the distance L2 is approximately 0.375 inches.

The height H is approximately 0.330 inches+/−0.010 and the width W is approximately 0.62 inches. The distance H1 is approximately 0.225 inches and the distance H2 between adjacent rows of holes 104 is approximately 0.75 inches.

FIG. 2 illustrates an exemplary stacking connector 200 that can be used with the pin alignment fixture 100 of the disclosed embodiments. In this example, the stacking connector 200 includes a plurality of pins 202 arranged in a pre-defined pattern 204. The pins 202 in this example have a length of approximately one to three inches. The hole pattern 106 in the board 102 of pin alignment fixture 100 of the disclosed embodiments can be configured to substantially match the pre-defined pattern 204 of pins 202, as is generally described herein.

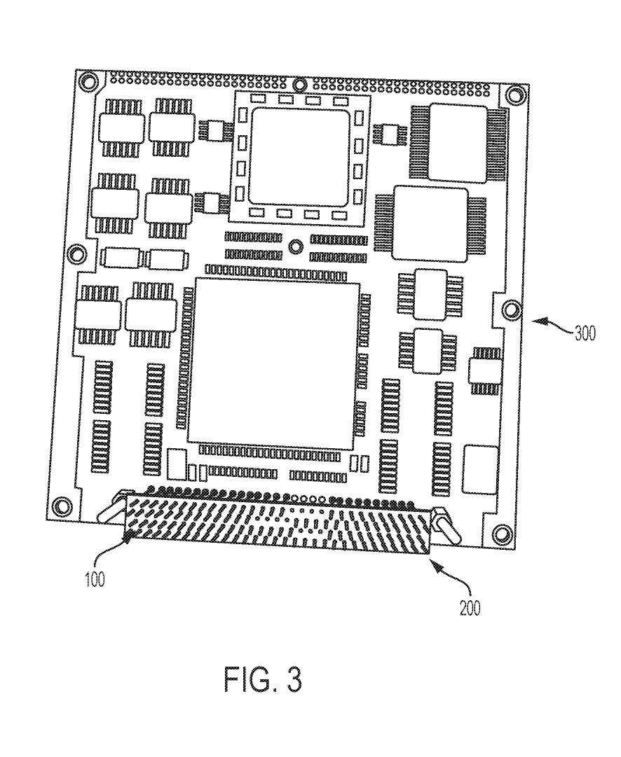

FIG. 3 illustrates one example of an avionics circuit board assembly 300 including a stacking connector 200 and a pin alignment fixture 100. In this example, the pin alignment fixture 100 is mounted over the pins 202 of the stacking connector 200.

In one embodiment, the pin alignment fixture 100 of FIG. 1 is installed onto the field of pins 202 shown in the examples of FIG. 2 and FIG. 3 by a technician or engineer. One all the pins 202 are successfully inserted into the corresponding openings 104 in the pin alignment fixture 100, the pin alignment fixture 100 is pushed downward onto the pins 202 so that the pin alignment fixture 100 cannot fall off.

In one embodiment, the pin alignment fixture 100 is configured to move up and down the connector pins 202 only if substantially equal forces are applied to each side of the board 102 of the pin alignment fixture 100. If a force from only one side of the pin alignment fixture 100 is applied that is not approximately the same as a force applied to the other side of the pin alignment fixture, due to the hole tolerancing, the pin alignment fixture 100 will not move, or will not easily move. This advantageously helps the pin alignment fixture 100 maintain the pins 202 in a substantially straight position or orientation as well as prevent the pin alignment fixture 100 from falling off of the connector 200.

The pin alignment fixture 100 of the disclosed embodiments advantageously aligns the pins 202 of a connector 200 with the receiving openings of a mating connector. In this manner, the pins 202 will not be bent when a force is applied to the mating connector parts of the connector assembly.

In one embodiment, once the mating connector parts 304 are mated together, the pin alignment fixture 100 is configured to slide over the pins 202 until a desired insertion position is reached. In this manner, the pin alignment fixture 100 remains with the connector assembly in the mated position.

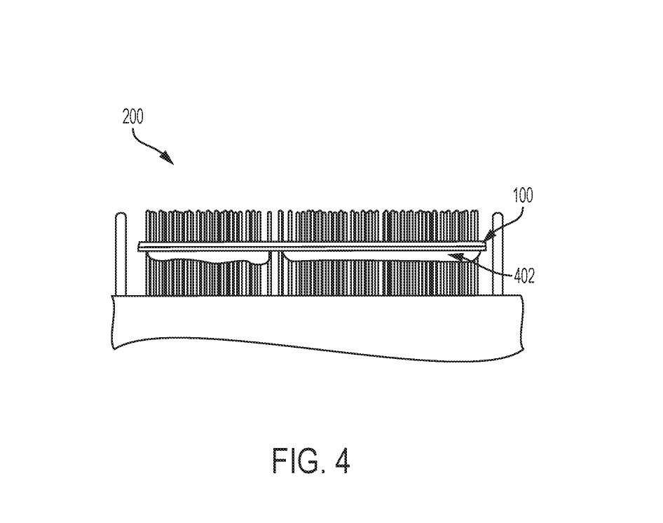

Referring to FIG. 4, in one embodiment, the position of the pin alignment fixture 100 on the pins 202 can be fixed. For example, an epoxy 402 can be applied to one or more of the pins 202, the holes 104 or other portions of the board 102 in a manner that will secure the board 100 in a desired position relative to the pins 202. This may be useful when the connector assembly 300 is used in a rugged environment, such as in rocket launch.

The pin alignment fixture 100 of the disclosed embodiments can be used with any connector that has pins that are not fixed on both ends. The design of the pin alignment fixture 100, such as the pattern and size of the holes 104 and the size of the board 102 can be changed to accommodate different pin diameters, pin spacing, the number of pins or any arrangement or pattern of pins.

The aspects of the disclosed embodiments advantageously maintain the pins of a connector, such as the long pins of a stacking connector, in a substantially straight position. In this manner, the pins cannot be easily bent or misaligned during handling. When the connector portions are mated together, the risk of a bent pin or a misalignment of the pin and receiving hole is minimized. This is particularly useful when the connector assembly or particular implementation requires a blind mate.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A stacking pin alignment fixture for a stacking connector, comprising:
a substrate;
a plurality of openings defined in the substrate, the plurality of openings being arranged in a predefined pattern, wherein the predefined pattern corresponds to a pattern of a field of straight pins arranged on the stacking connector.

2. The stacking pin alignment fixture of claim 1, wherein the substrate comprises an electrically non-conductive board.

3. The stacking pin alignment fixture of claim 2, wherein the substrate is a substantially stiff board having a thickness of approximately 1 millimeter.

4. The stacking pin alignment fixture of claim 1, wherein the plurality of openings in the substrate are configured to be aligned with the pattern of the field of straight pins of the stacking connector when the substrate is placed onto the field of straight pins.

5. The stacking pin alignment fixture of claim 4, wherein the substrate is configured to move up and down a length of each straight pin in the field of straight pins when a substantially equal force is applied to both sides of the substrate.

6. The stacking pin alignment fixture of claim 4, wherein the substrate is configured to maintain each pin in the field of straight pins in a substantially straight position when the substrate is placed onto the field of straight pins.

7. The stacking pin alignment fixture of claim 6, wherein a length of each pin in the field of straight pins is approximately three-inches.

8. The stacking pin alignment fixture of claim 1, wherein the pre-defined pattern corresponds to an Airborn HMM series connector with 122 pins.

9. The stacking pin alignment fixture of claim 1, wherein a length of the substrate is approximately three-inches, and a thickness is approximately 1 millimeter.

10. The stacking pin alignment fixture of claim 1, wherein the substrate is configured to slide up and down the pins in the field of straight pins.

11. A stacking pin connector configured for space flight, comprising:
a plurality of spaced-apart straight pins arranged in a pre-defined pattern on a first portion of the connector;
a mating portion of the connector comprising a plurality of openings, wherein each opening is configured to receive a straight pin of the plurality of straight pins; and
a substrate having a plurality of spaced-apart openings defined therein, the plurality of spaced-apart openings being arranged in a pattern corresponding to the pre-defined pattern of spaced-apart straight pins, wherein the substrate is configured to be mounted onto the plurality of spaced-apart straight pins to maintain each pin in a substantially straight position.

12. The connector of claim 11, wherein the substrate is configured to be positioned between the first portion of the connector and the mating portion of the connector when the first portion is connected to the mating portion.

13. The connector of claim 11, wherein the substrate is a substantially stiff board member, having thickness of approximately 1 millimeter.

14. The connector of claim 11, wherein the substrate is configured to slide up and down the plurality of pins when equal forces are applied to each side of the substrate.

15. The connector of claim 11, wherein the substrate substantially prevents lateral movement of the straight pins in the plurality of pins.

16. The connector of claim 11, wherein the connector is a 122-pin stacking connector.

17. The connector of claim 11, wherein the connector is a stacking connector for an avionics assembly board of a spacecraft.
